(19) United States
(12) Patent Application Publication
(10) Pub. No.: US 2023/0079175 A1
(43) Pub. Date: Mar. 16, 2023

(54) AUTO RECOVERY CIRCUIT BREAKER AND AUTO RECOVERY CIRCUIT BREAKER WITH TRANSMITTER

(71) Applicant: L&T TECHNOLOGY SERVICES LIMITED, Chennai (IN)

(72) Inventors: Jinith PUTHIYOTTIL, Calicut (IN); Daireddy ANJANEYULU, Vijayawada (IN)

(21) Appl. No.: 17/945,619

(22) Filed: Sep. 15, 2022

(30) Foreign Application Priority Data
Sep. 16, 2021 (IN) 202141041834

(51) Int. Cl. H02H 3/16; H02H 1/00

(52) U.S. Cl. CPC H02H 3/16; H02H 1/0007

(57) ABSTRACT

An auto recovery circuit breaker (ARCB) device is disclosed that may include a step-down transformer which may provide a low voltage AC test signal to detect a fault in a phase line or neutral of an electric circuit. A first current transformer (CT) is positioned on the first line, and a second CT is positioned on the second line. Each of the first CT and the second CT may sense a current flowing through the electric circuit, and detect an earth leakage through the electric circuit. A microcontroller is configured to: monitor the analog signal in the circuit, detect earth leakage before powering ON the circuit, detect output short before power ON, and upon detection of a fault removal in the electrical circuit, turn ON a relay. Once turned ON, the ARCB device may continue test by sensing the CT’s provided in the phase and neutral lines.

### DESCRIPTION

### CROSS REFERENCE TO RELATED APPLICATIONS

The present application claims priority to Indian Application No. 202141041834 filed with the Intellectual Property Office of India on Sep. 16, 2021 and entitled “AUTO RECOVERY CIRCUIT BREAKER AND AUTO RECOVERY CIRCUIT BREAKER WITH TRANSMITTER,” which is incorporated herein by reference in its entirety for all purposes.

### TECHNICAL FIELD

The present invention relates to an intelligent circuit breaker for safety, and more particularly to an intelligent circuit breaker device having an automatic recovery capability.

### BACKGROUND OF THE INVENTION

“Electric leakage” may refer to a current leak in an electrical circuit that may end up causing an accident, for example, fire. When an insulator of a coating layer of an electric wire (electrical line) or an electrical product fails due to ageing or mechanical damage, an electric current can flow into ground wire through conductor when somebody touches it. An earth leakage circuit breaker (ELCBs) or miniature circuit breaker (MCBs) are typically installed where electrical products are used to protect people and property from electric leakage. When there is an electric leakage or excess load/short circuit, a typical ELCB or MCB operation is to forcibly cut off the power supply to the electrical product. If there is a one-time short/short interval inrush current, it must be manually switched ON once it has tripped.

However, the ELCB may not be able to detect an occurrence of earth leakage prior to turning ON. It can only trip the circuit after the person has received a brief electric shock. As such, this could prove life-threatening. The ELCB may only trip after a few seconds if the person has received an electric shock. Although, when a fault occurs, the MCB act as a circuit breaker; however, the MCB may not be able to detect the short-circuit or overcurrent output unless turned ON. This may therefore cause damage to sensitive electrical equipment or wiring.

### SUMMARY OF THE INVENTION

In an embodiment, an auto recovery circuit breaker (ARCB) device is disclosed. The ARCB device may include a step-down transformer which will produce a low AC test voltage to check the output status before switching the 220VAC to load. The ARCB device may further include a first current transformer (CT) positioned on the first line, and a second CT positioned on the second line. Each of the first CT and the second CT may be configured to: sense a current flowing through the electric circuit, and by comparing the difference in phase and neutral line current it can detect earth leakage. Also, by reading the current linearly by CT, the ARCB device may detect over current and short circuit. The ARCB device may further include a microcontroller configured to: monitor the analog signal in the circuit, detect earth leakage before powering ON the circuit, detect output short before power ON, and upon detection of a fault removal in the electrical circuit turning ON a relay. The relay may be used to switch the main power to load ON or OFF. When the relay is OFF, the relay will be switched to a low voltage test line and it may keep monitoring the output status. The ARCB may further include a display configured to indicate a type of fault detected and allow setting an over-load current trip, an earth leakage trip current, an over voltage cut-off limit using one or more keys.

In another embodiment, an auto recovery circuit breaker with transmitter (ARCBT) device is disclosed. The ARCBT may include a step-down transformer which may be configured to: detect a fault in a first line or a second line of an electric circuit, and generate a sense voltage based on the detection. The ARCBT device may further include a first current transformer (CT) positioned on the first line, and a second CT positioned on the second line. Each of the first CT and the second CT may be configured to: sense a current flowing through the electric circuit, and detect an earth leakage through the electric circuit. The ARCBT device may further include a microcontroller configured to: monitor the analog signal in the circuit, detect earth leakage before powering ON the circuit, detect output short before power ON, and upon detection of a fault removal in the electrical circuit within a predetermined period of time, turning ON a relay. The relay may be used to switch the electrical circuit load ON or OFF. The ARCBT device may further include a transmitter communicatively coupled to a server. The transmitter may be configured to: monitor a status of the electrical circuit, a failure reason, a duration of fault, an earth leakage, and receive instruction for processing by the microcontroller.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a schematic diagram of an electrical circuit implemented with an auto recovery circuit breaker (ARCB) device, in accordance with an embodiment of the present disclosure.

FIG. 2 illustrates a schematic diagram of an electrical circuit implemented with an auto recovery circuit breaker and a transmitter (ARCBT) device, in accordance with an embodiment of the present disclosure.

FIG. 3 illustrates a schematic diagram of an example electrical circuit of a residential or office premises implemented with an ARCB device, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The disclosure related to an auto recovery circuit breaker (ARCB), a new generation microcontroller-based intelligent AC circuit breaker for use with 230 V AC lines. It can directly replace MCB and ELCB of current generation. ARCB is a hybrid of the MCB and ELCB circuit breakers that can withstand the drawbacks of current generation circuit breakers. The ARCB is designed for commercial and industrial applications that use circuit breakers. The ARCB is provided with additional features such as pre-detection of short circuit, overload and pre-detection of electric shock. Further, the ARCB has numerous commercial applications that can be implemented at residential premises, industrial premises, etc.

The ARCB is capable of pre-detection of fault (earth leakage, accidental electric shock, short circuit, over current, etc.) in the electric line before the 220 VAC/415 VAC feed to output. At first, the ARCB will check the output load status with a low voltage AC. It will turn on the actual supply to load only when the test is passed with a low AC test voltage. This test voltage is a very low AC voltage which cannot create any electric shock effect to human. Once the actual supply is switched to output, it will continue check for over current, earth leakage, etc., same as a normal ELCB and MCB. Once it trips, it will again enable low voltage test path and continue the test. If the check is passed after removal of output fault, it will automatically recover. Hence, it can offer below-mentioned safety before line voltage appears at the load. It can detect if any person has touched the phase line or neutral line before the actual supply is switched on. Further, it can detect over current and short circuit at the output.

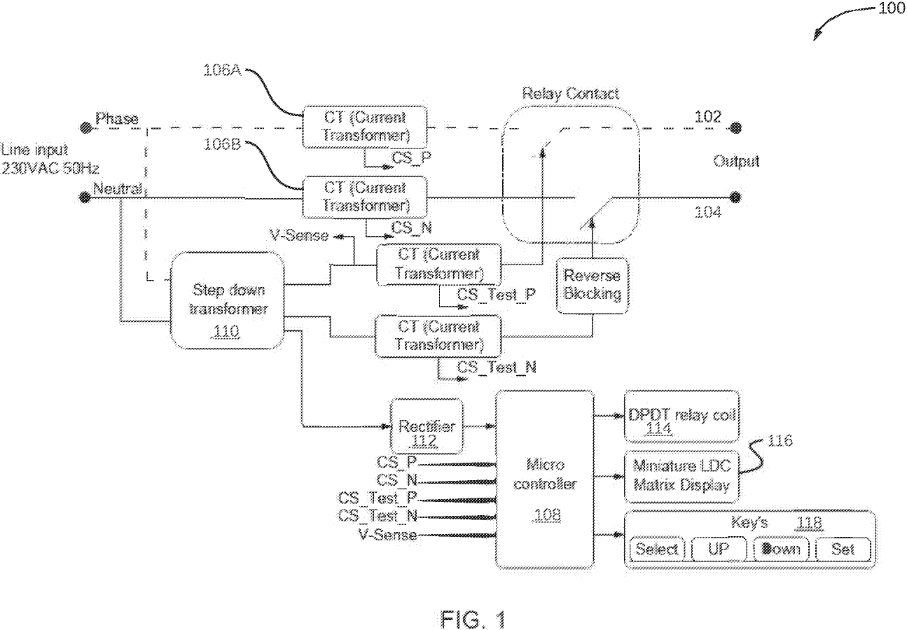

Referring to FIG. 1, a schematic drawing of a electrical circuit 100 implemented with an auto recovery circuit breaker (ARCB) device is illustrated, in accordance with an embodiment of the present disclosure. An alternating current (AC) from a phase line 102 and a neutral line 104 may pass to a current sensor or current transformer (CT) 106A, 106B. The CT 106 may be used to sense the current flowing through the circuit 100 and this analog signal may be continuously monitored by a microcontroller 108 - CT may be provided kept in each line separately by measuring the earth leakage. The same current from both the lines 102, 104 may pass through a stepdown transformer 110 which may output the level of current passing through it with a proportional voltage value. This voltage value is small and can be used as test voltage. With the help of this voltage, a fault in the output lines can be detected. Another winding of the transformer can be used for powering the microcontroller 108 and internal circuitry. In a nutshell, two-high accuracy CTs 106A, 106B mat be provided to sense signal generated proportional to the current, so as to detect the earth leakage before powering ON. Also, a short output before powering ON of the circuit 100 can be detected. Furthermore, the output received from the stepdown transformer 110 may pass through a rectifier 112 where the AC supply may be converted to direct current (DC) supply. The rectified voltage supply may be fed to the microcontroller 108.

The current sensor may report current levels to the microcontroller 108. The microcontroller 108 may compare the values with a set threshold value which the circuit should not exceed. If the threshold value is reached, the microcontroller 108 may send the control signal to disconnect the main line. This action is carried out by a DPDT relay 114 within the circuit 100.

A miniature LCD 116 may be provided a matrix display for indicating that what kind of fault is detected, and it to set overload current trip, earth leakage trip current, over voltage cut-off limits with the help of one or more (e.g. four) keys 118 on its front panel. The one or more keys may be named as select, up, down, and, set keys.

The circuit 100 may further include a double pole double throw (DPDT) relay 114 driven by digital output of the microcontroller 108 to sense a fault condition and to operate according to a controlling algorithm. The DPDT relay 114 may be used for the load to ON and OFF. The controlling algorithm on which the DPDT relay 114 works is designed in such a way that it will turn ON relay only after ensuring the fault removal from the line. This process is initiated by the microcontroller 108, and it is a fully automatic test.

The circuit 100 implementing the ARCB may begin to operate before the load is turned on. Before turning on the AC line to load, the ARCB may perform the following checks. It may use the phase line 102 or the neutral line 104 to check for human contact. A check for short circuit and check for overload may be performed. Once this test is passed, it will confirm there is no fault. Thereafter, it may automatically switch ON the phase line 102 and the neutral line 104 to its outputs. Once the output load is switched ON, it will continue to check earth leakage (as a normal ELCB) and over current, short circuit (as normal MCB). Once over current or short circuit occurs, it trips off the circuit and at the same time it will check whether the fault still exists or not, without switching on the output directly. If the fault is removed within a predetermined period of time (for example, 10 seconds), it will automatically turn on the switch (auto recovery). If the same fault occurs again within 10 seconds of time or the fault is not removed in 10 seconds, it will permanently switch OFF the load for safety purpose. At this time, manual interaction is required to switch ON, after fault removed. The ARCB device may exhibit reverse blocking capability (prevent current from flowing from the output to ARCB circuitry).

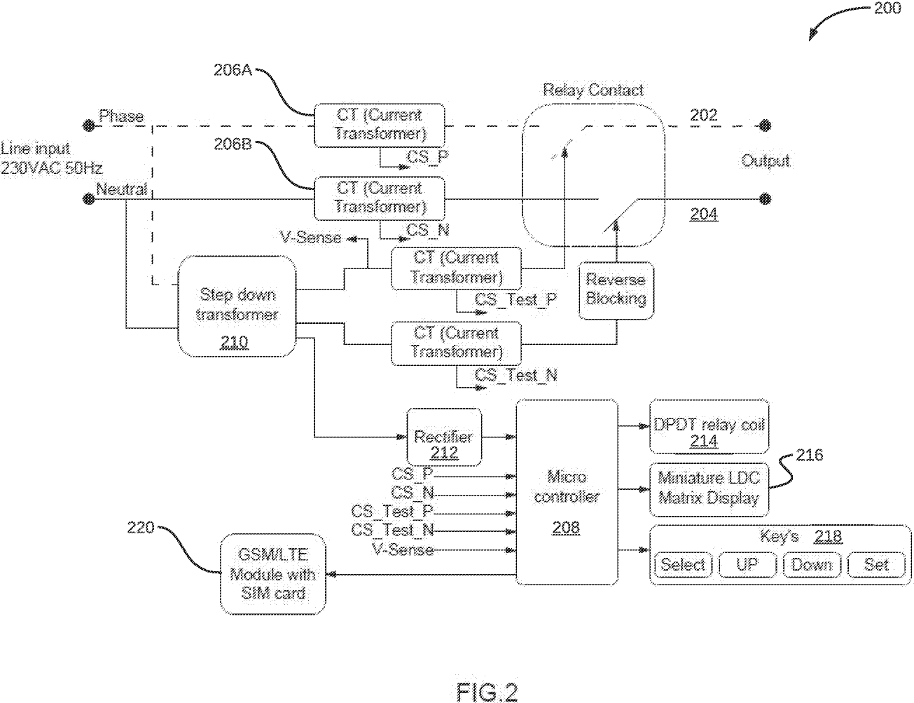

Further, an auto recovery circuit breaker with transmitter (ARCBT) is disclosed that is an advanced version of ARCB. The ARCBT may have the same configuration with the only difference that the ARCBT may additionally include a wireless transceiver to communicate and control through Internet. Referring to FIG. 2, a schematic diagram of an electrical circuit 200 implemented with an auto recovery circuit breaker and a transmitter (ARCBT) device illustrated, in accordance with an embodiment of the present disclosure. A current sensor or current transformer receives alternating current (AC) from a phase line 202 and a neutral line 204. The current flowing through the circuit 200 is sensed by a current transformer (CT) 206A, 206B, and an analogue signal is continuously monitored by a microcontroller 208. The CT 206A and the CT 206B may be kept in each line 202, 204 separately. And the same current from both lines 202, 204 may pass through a stepdown transformer 210 which may output the current level with a small proportional voltage value that is used as a test voltage. The transformer may sense the output voltage. The ARCBT device may further detect faults in output lines 202, 204 with the help of this voltage. The microcontroller 208 and internal circuitry may be powered by another winding of the same transformer.

Before turning on the power, the two high-accuracy CTs 206A, 206B may be placed to sense the signal path and detect any earth leakage or if any person has touched the phase line or neutral line, and also detect output shorts before turning on. In addition, the output from the stepdown transformer 210 passes through the rectifier 212, which converts the AC supply to direct current (DC). The microcontroller 208 could be powered by the rectified voltage supply. The device includes a miniature LCD 216 with matrix display to indicate the type of fault detected, and it is used to set overload current trip, earth leakage trip current, and over voltage cut-off limits using four keys on its front panel. Further, the circuit 200 may include four keys 218, select key, up key, down key, and set key. The microcontroller 208 may receive current levels from the current sensor. The microcontroller 208 may further compare the values to a preset limit that this system must not exceed. The microcontroller 208 may send a control signal to disconnect the main line when the threshold value is reached. A relay 214 may be responsible for this action. If this test is passed, this means there is no problem. To sense a fault condition and operate according to a controlling algorithm, the ARCBT may be is equipped with a DPDT relay driven by the microcontroller 208. The DPDT relay 214 may be used to turn on and off the load. The controlling algorithm is programmed to turn on the relay 214 only after the fault has been removed from the line. The microcontroller 208 may initiate this process, which is a fully automated test.

The circuit may further include a built-in transceiver 220 (i.e. a transmitted and a receiver). The transceiver 220 may be used to communicate between the server and the ARCBT 200. It can monitor the status, the cause of the failure, the duration of the fault, the earth leakage, and change the settings from the Section office via the cloud. To manage multiple ARCBTs with a computer, a dedicated user interface can be used. This user interface may include the following features: an alarm which may trigger whenever any of the ARCBT detects a fault, it allows remotely changing the settings of ARCBT.

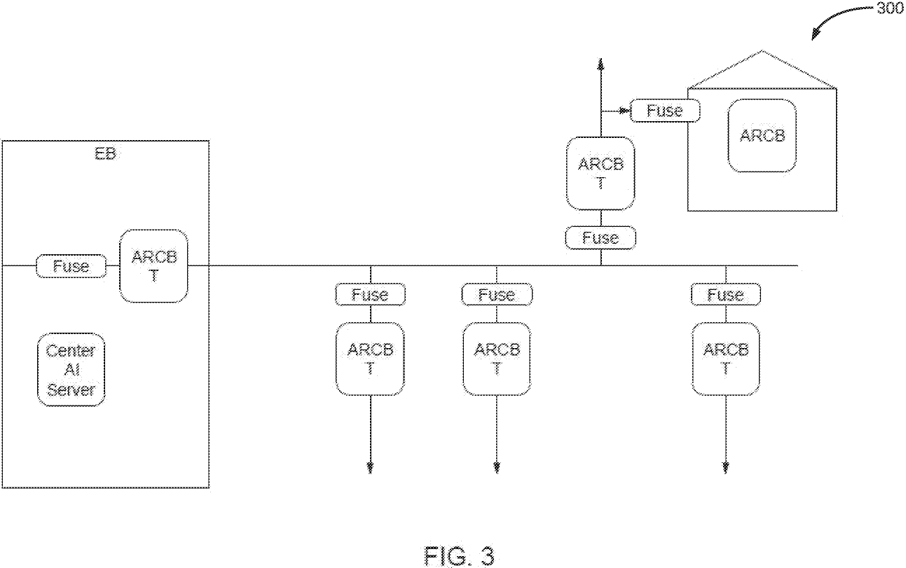

Referring to FIG. 3, a schematic diagram of an example electrical circuit 300 of a residential or office premises implemented with an ARCB device is illustrated, in accordance with an embodiment of the present disclosure. For example, the ARCB or the ARCBT may be used instead of conventional circuit breakers.

The ARCB and ARCBT disclosed above provide various technical advantage in comparison with ECLB and MCB. For example, the technical advantage include capability for over voltage protection, short circuit protection, pre-detection of short circuit, earth leakage protection, pre-detection of earth leakage, auto recovery after removal of short circuit, wireless monitoring and control.

It is intended that the disclosure and examples be considered as exemplary only, with a true scope and spirit of disclosed embodiments being indicated by the following claims.

We claim:

1. An auto recovery circuit breaker (ARCB) device comprising:
a step-down transformer followed with a first current transformer (CT) and a second CT, the step-down transformer configured to:
detect a fault in a phase line or neutral line, by feeding a low voltage AC signal to an output transmission line before enabling power to load;
wherein each of the first CT and the second CT is configured to:
sense a current flowing through the electric circuit;
detect an earth leakage through the electric circuit; and
detect a human contact with the phase line or the neutral line; and
a microcontroller configured to:
monitor the analog signal in the circuit;
detect earth leakage before powering ON the circuit;
detect output short before power ON; and
upon detection of a fault removal in the electrical circuit, turning ON a relay, wherein the relay is used to switch the electrical circuit load ON or OFF.

2. The ARCB as claimed in claim 1, comprising a display configured to:
indicate a type of fault detected; and
set an over-load current trip, an earth leakage trip current, an over voltage cutoff limit using one or more keys.

3. The ARCB as claimed in claim 1, wherein the microcontroller is powered by the step-down transformer.

4. An auto recovery circuit breaker with transmitter (ARCBT) device comprising:
a step-down transformer followed with a first current transformer (CT) and a second CT, the step-down transformer, configured to:
detect a fault in a phase line or a neutral line, by feeding a low voltage AC signal to an output transmission line before enabling power to load.
wherein each of the first CT and the second CT is configured to:
sense a current flowing through the electric circuit;
detect an earth leakage through the electric circuit; and
detect a human touched with the phase line or the neutral line; and a microcontroller configured to:
monitor the analog signal in the circuit;
detect earth leakage before powering ON the circuit;
detect output short before power ON; and
upon detection of a fault removal in the electrical circuit, turning ON a relay, wherein the relay is used to switch the electrical circuit load ON or OFF; and a transmitter communicatively coupled to a server, wherein the transmitter is configured to:
monitor a status of the electrical circuit, a failure reason, a duration of fault, an earth leakage; and
receive instruction for processing by the microcontroller, wherein the ARCBT is configured to communicate and be controlled via Internet.

5. The ARCBT device comprising:
an alarm device configured to generate an indication for detection of the fault; and an input button to change the settings of the microcontroller.
